(19) United States
(12) Patent Application Publication
(10) Pub. No.: US 2002/0107871 A1
(43) Pub. Date: Aug. 8, 2002

(54) Method and system for database migration and association

(75) Inventors: Wojciech J. Wyzga, Tucson, AZ (US); William J. Oliver, Tucson, AZ (US); Michael S. Williams, Tucson, AZ (US)

Correspondence Address: Squire, Sanders & Dempsey L.L.P., Two Renaissance Square, Suite 2700, 40 North Central Avenue, Phoenix, AZ, 85004-4498, US

(73) Assignee: Knowledge Computing Corporation

(21) Appl. No.: 10/068,318

(22) Filed: Feb. 5, 2002

Related U.S. Application Data
(60) Provisional application No. 60/266,436, filed on Feb. 5, 2001.

(51) Int. Cl. G06F 7/00

(52) U.S. Cl. 707/104.1

(57) ABSTRACT

A system for data mining and warehousing is provided. The system includes a client computer running a web browser. In conjunction with the web browser is an applet that helps to sort, decompress, compress, encrypt and unencrypt data. A remote server is coupled to the client computer and sends the web browser search forms after the web browser requests them and receives a search query from the web browser. A connect/detect database is coupled to the remote server that receives the search query at a database view. Data is then retrieved from a database table. The database tables contain data from one or more legacy databases. The data in the legacy databases are copied to the database tables using a migration engine coupled to a migration database. The database can be search to retrieve data related to a search term or retrieve the data related to a search term and additional data associated with the data related to the search term.

### FIELD OF THE INVENTION

This invention relates to the field of web-enabled software and data warehousing and data mining, and more particularly to a method and system for database migration and association.

### BACKGROUND OF THE INVENTION

In today's law enforcement environment, information is key to efficient and prompt investigations. Law enforcement organizations have many databases storing a wealth of information regarding criminal activity. However, many of these databases are maintained by entities within a law enforcement jurisdiction. For example, a gang task force might maintain a database related to known gang members while a property crime section may have detailed information related to property crimes. While each entity may be able to search their own databases, the information may not be accessible by other entities for several reasons. First, the database and search software in different entities maybe incompatible. Second, the organizations may lack a central database to store all the information. This may lead to problems. For example, a police officer may detain a suspect and, by not knowing to search the gang member database, by unaware the suspect is a member of a gang. Not only does this problem exist within an organization, incompatible databases and information spread throughout many databases exist between law enforcement organization; for example, between the police departments of different cities.

The drawbacks with the present system are many. First, the system is typically dependent on a system that contains proprietary elements and is not compatible with other systems in an organization. Second, current systems with multiple databases do not allow a user to search for association between the data stored in the different databases. These are a few of the many drawbacks of present systems.

### SUMMARY OF THE INVENTION

Thus, a need has arisen for a method and system for database migration and association that overcomes the drawbacks and disadvantages of present systems. In one embodiment a method for retrieving law enforcement data from one or more legacy databases is disclosed. First, a connect/detect database is formed by migrating data from one or more legacy databases and storing the results in a connect/detect table. Then, a search query is received containing one or more search terms related to a law enforcement at a web server coupled to the connect/detect database. Next, data matching at least one or more of the search terms is retrieved from the connect/detect database based on the search query.

In another embodiment, an integrated police database search system is disclosed. The system comprises a law enforcement database formed by migrating existing data from one or more pre-existing databases to a central database. Additionally, a server is coupled to the law enforcement database. The server is operable to receive search requests having one or more law enforcement search terms. The server is operable to parse the search request and to retrieve data matching at least one or more of the search terms. The server is further operable to send the data back to a user.

The present invention provides technical benefits over prior methods and systems. For example, data is consolidated into a single database that can be easily searched by an individual. Also, the use of a client computer running a web browser allows for the use of search pages that are not hard coded and that can be accessed from remote locations. Other technical benefits are apparent from the following descriptions, illustrations and claims.

### BRIEF DESCRIPTION OF THE DRAWINGS

For a more complete understanding of the present invention and advantages thereof, reference is now made to the following descriptions, taken in conjunction with the following drawings, in which like reference numerals represent like parts, and in which:

FIG. 1 is a block diagram of a database collection/analyzer system;

FIG. 2 is a block diagram of an alternate embodiment of the database collection/analyzer system;

FIG. 3 is an example of a connect search screen;

FIG. 4 is an example of a connect result screen;

FIG. 5 is an example of a detect search screen;

FIG. 6 is an example of a detect result screen; and

FIG. 7 is a block diagram of a multi-user embodiment of the present invention.

### DETAILED DESCRIPTION OF THE DRAWINGS

Turning first to the nomenclature of the specification, the detailed description that follows is represented largely in terms of processes and symbolic representations of operations by conventional computer components, including a central processing unit (“CPU”) or processor associated with a general purpose computer system, memory storage devices for the CPU, and connected pixel-oriented display devices. These operations include the manipulation of data bits by the CPU and the maintenance of these bits within data structures resident in one or more of the memory storage devices. Such data structures impose a physical organization upon the collection of data bits stored within computer memory and represent specific electrical or magnetic elements. These symbolic representations are the means used by those skilled in the art of computer programming and computer construction to most effectively convey teachings and discoveries to others skilled in the art.

For the purposes of this discussion, a process or method is generally considered to be a sequence of computer-executed steps leading to a desired result. These steps generally require manipulations of physical quantities. Usually, although not necessarily, these quantities take the form of electrical, magnetic, or optical signals capable of being stored, transferred, combined, compared or otherwise manipulated. It is conventional for those skilled in the art to refer to these signals as bits, values, elements, symbols, characters, text, terms, numbers, records, files, or the like. It should be kept in mind, however, that these terms and others should be associated with appropriate physical quantities for computer operations, and that these terms are merely conventional labels applied to physical quantities that exist within and during operation of the computer.

In addition, it should be understood that the programs, processes, methods, etc. described herein are but an example of one implementation of the present invention and are not related or limited to any particular types of general purpose computing machines or devices that may be used with programs constructed in accordance with the teachings described herein. Similarly, it may prove advantageous to construct a specialized apparatus to perform the method steps described herein by the way of dedicated computer systems with hardwired logic or programs stored in non-volatile memory, such as read-only memory.

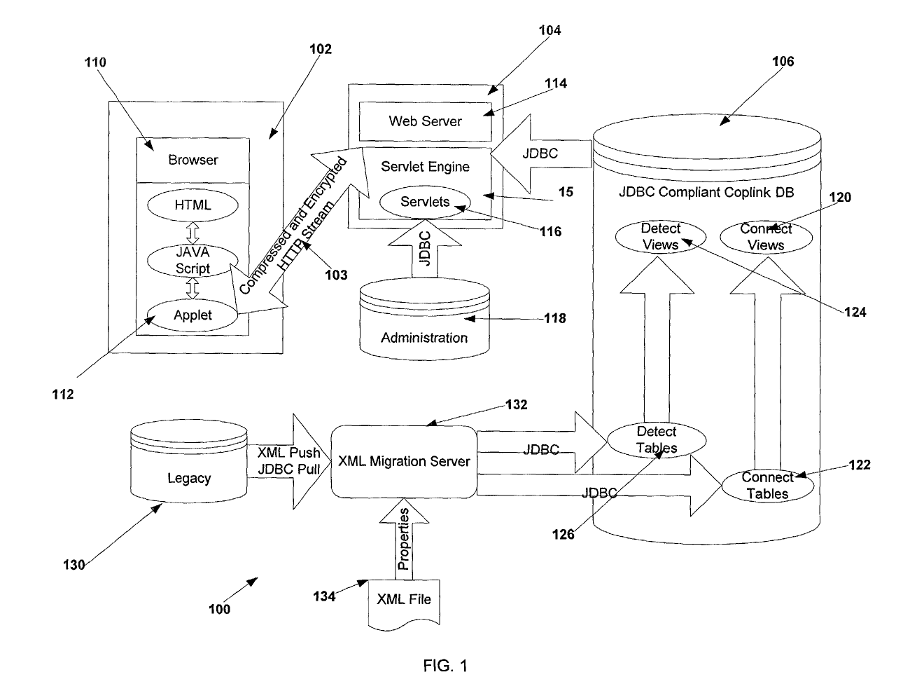

FIG. 1 is a block diagram of an improved database collection and analyzer system 100. Illustrated is a client computer 102 coupled to a web server 104. Web server 104 is, in turn, connected to a connect/detect database 106.

Client computer 102 can be any computing device capable of accessing other computers in a networked environment including a personal computer, a hand held computer or personal digital assistant and the like. Client computer 102 is preferably a personal computer having a processor, a printer, an input device such as a keyboard and/or mouse, a monitor, a floppy disk drive, memory, a modem and/or computer network interface, and a mass storage device such as a hard disk drive and/or a readable/rewritable CD-ROM drive. Client computer 102 operates under the control of an operating system such as WINDOWS 95/98/2000/NT/ME/XP, OS/2, UNIX, LINUX, MAC OS and the like. Client computer 102 is operable to run a web browser 110.

Web browser 110 is operable to run on client computer 102. Web browser 110 is communicates with web server 104 using a protocol such as HTTP. Web browser 110 is operable to receive information in a mark-up language such as HTML and output a formatted display. Entering the web address or uniform resource locator (URL) of an Intranet or Internet page will retrieve information from a remote server and display the information on client computer 102. In the present invention, the user of client computer 102 will utilize the web browser 110 to search connect/detect database 106. Thus, the user will enter the URL of the search page into the browser. Alternatively, web browser 110 will include a shortcut that can be selected to access the search page. Web browser 110 may also be a script-enabled browser. Web browser 110 is able to run scripting languages such as JAVAScript or Jscript to enhance the browser display by helping to draw user interfaces and making displays that are responsive to user interaction. Web browser 110 is also able to execute dynamic HTML pages that can be updated automatically.

An applet 112 may also be running in conjunction with the web browser 110. An applet is a module of code, written in a programming language such as JAVA, that runs in conjunction with the web browser 110 to enhance the web browser's 110 functionality or to add content to web browser 110. In the present invention, applet 112 can be used to compress/decompress and encrypting/unencrypt information sent to and received from the web server 104. Applet 112 can also sort data and keep track of data returned from web server 104. The functionality of applet 112 may be, in large part replaced by a similarly functioning servlet 116 at the web server 104. However, it is often more efficient to provide a client side applet 112. By providing a client side computer running a web browser 110, the web server 104 and hence the search functions of the present invention can be accessed from any place where the client computer 102 can connect to the web server 104. In the case where the connection is over the Internet, the client computer could be located anywhere there is an Internet connection.

Web server 104 is a computer, such as a personal computer, file server, workstation, mini-computer, mainframe, or any other computer capable of communicating and interconnecting with other computers. Web server 104 will preferably include a processor, an input-device such as a mouse and/or keyboard, a monitor, memory, a modem or other means of communicating with other computers, a mass storage device such as a hard disk drive or optical disk drive and a floppy disk drive. Web server 104 will operate under the control of an operating system such as WINDOWS NT/2000, UNIX, LINUX, MACINTOSH OS and the like. A communication line 103 couples client computer 102 with web server 104. Communication line 103 may be any type of communication link capable of supporting data transfer. For example, these communication lines may include any combination of an integrated service digital network (ISDN) communication line, a hard-wired line, a telephone link, a digital subscriber line, a cable connection, a fiber optic link, or a wireless connection. The communication line 103 will support the transfer of an HTTP stream between client computer 102 and web server 104. The HTTP stream may be compressed for efficiency purposes. In one embodiment, communication line 103 is a connection over the Internet. The connection may also be a private local area network, wide area network, a virtual public network or the like.

A web server application 114 will be running on the web server 104. The type of web server application depends upon the operating system running on the web server 104. For example, if the web server 104 is running a UNIX operating system, the web server application 114 may be an Apache web server application.

A servlet engine application will be running on web server 104. The type of server engine application depends on the operating system and the web server application installed on the web server system. For example, if the web server 104 is running the UNIX operating system with an Apache web server application, the servlet engine may be the TOMCAT servlet engine application.

One or more servlets 116 may also be running under a servlet engine 115. A servlet 116 is a module of code, typically written in as JAVA code, which runs in a server application to answer client requests. These can be contrasted with applets, which run on the client computer 102. In the present invention, servlets 116 will be able to help to return the results of a database query to a client, as well as validate user security, compress and encrypt data and perform other functions to assist the web server application 114 in sending information back to the web browser 110. Coupled to web server application 114 is an administration database 118, which communicates with the web server application 114 through the servlets 116 using a protocol such as the Java database cartridge or oracle database cartridge (JDBC/ODBC). The purpose of the administration database 118 is to provide information to help format the data being returned to the web browser 110 for presentation to client computer 102 and store user authorization data and profiles.

Also coupled to the web server 104 and in communication with web server application 114 is the detect/connect database 106. The connect/detect database 106 holds information for both the detect system and connect system. The connect/detect database, in one embodiment, is a police/law enforcement database. The connect system is used to perform queries which formerly were done on different databases throughout an organization, but are now done on a single database to increase efficiency. The detect database is used to help detect trends in the information provided by the connect database.

Connect/detect database 106 contains connect views 120 and connect tables 122 along with detect views 124 and with detect tables 126. The connect table 122 and detect table 126 are populated from legacy databases 130. Legacy databases 130 are databases which contain information in a format that is no longer supported by more modern programs or the legacy databases 130 may comprise several databases which are built using different database programs such that one program cannot read the data from the other database. Additionally, legacy databases may comprise several databases, which are dispersed through out an organization, or several organizations. Legacy database 130 can also be a more modern database management system such as Microsoft SQL server, Oracle 8, or IBM DB2. Alternatively, legacy databases 130 may be multiple databases containing information that a user wants to have in one central location such as a variety of databases existing in different organizations through out a law enforcement organization. A migration server 132 is couple between the legacy database 130 and the connect/detect database 106. The migration server 132 is used for two purposes. First, the migration server 132 inputs the data from the legacy databases 130 and takes the information from a format file such as a extensible markup language (XML) file 134 and uses that to populate the connect table 122 and detect table 126. The XML file 134 indicates how to populate the connect table 122 and detect table 126. One way to extract information from legacy database 130 is to pull the information off legacy database 130 using a Java database cartridge or similar protocol. In another environment, legacy database 130 pushes information to the migration server 132. In this case, migration server 132 includes a XML parser to extract the data from the XML format. The use of XML in conjunction with database queries is well known in the art of computer programming. By using the XML push system, as information is updated to the legacy databases, the changes can be pushed to the migration server 132 and the connect table 122 and detect table 126 can be updated. Connect table 122 is used to store the data that was in the preexisting database and that can be retrieved via a search request. Detect database stores the relationships between the data extracted such that not only will a search inquiry retrieve certain data, but also other information associated with the data. In this manner, not only is information stored in a central location, the association between data can be searched. Thus data that was previously searchable only separately can now be examined to see if it is related to other data from other entities or law enforcement organizations. A connect search and detect search are discussed in detail below.

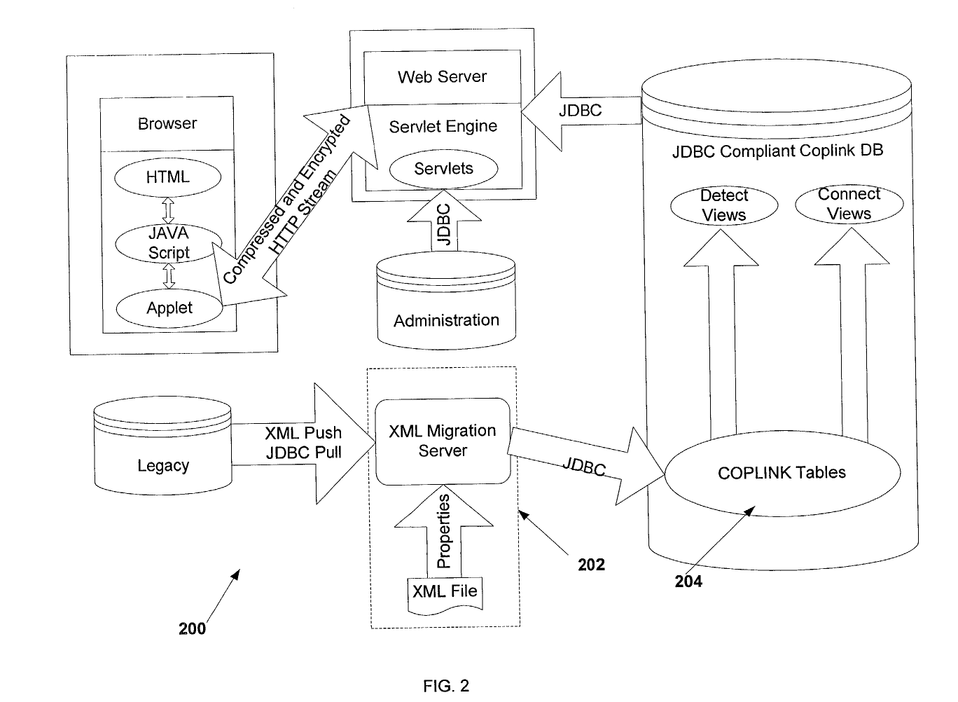

In another embodiment, as illustrated in FIG. 2, XML file 134 and migration server 132 are integrated as a XML migration server 202. Combining the functionality of several components into a XML migration server 202 increases efficiencies. Additionally, the separate connect tables 122 and detect tables 126 can be integrated as a single connect/detect table 204 that is used. Data can still be saved in any legacy databases. Then as illustrated in FIG. 2 periodically, the connect tables 122 and detect tables 126 can be updated by either pulling data from the legacy databases or receiving the data from a data socket listener in the XML migration server 202 using XML push. In this manner, if separate entities within an organization maintain separate databases the present invention can be used to collect data from all of the databases into a single location for ease of searching. Associations/relationships between objects in the database are extracted from the incoming data and stored in the detect tables to provide an index into the data stored in the connect table, thus allowing quick retrieval of related data. The association and relations between data is determined, in one embodiment from the imported data. For example, when data concerning persons, vehicles, incidents, and location for a law enforcement database is imported, the names, incidents, locations, and vehicles that are associated can be stored in the detect table 126 as in FIG. 1 or as part of the connect/detect table 204. In another embodiment, the relationships between imported data can be determined mathematically using algorithms that associate data. Depending on space constraints, the relationship between data can be stored in detect table 126 or the relationships and data can be stored.

The following is a description of how a user of the system for database migration and association uses the system. The example discusses the use of the system in a law enforcement environment. This example uses the system of FIG. 1 although the operation of the system of FIG. 2 is similar. This example is for illustration purposes and is not intended to limit the application of the present invention.

In operation, a police officer has information gathered from an investigation such as the make and model of a suspect's car or the alias of a suspect. Knowing the information, the police officer will run the web browser 110 on client computer 102. Then the police officer will enter the web address of the Intranet or Internet page where the search page screen is located. The request is sent to the server 114 using the HTTP protocol and a login screen is presented to the police officer. The police officer enters personal login information that is sent back to the servlets 116 in the server 114. In the servlets 116 a security protocol is run, verifying the user's identity and clearance. If the identity clears the security protocol the servlets 116 sends back a collection of search pages and an applet to the client browser 110 to setup a client interface. A search page is sent back to the web browser 110 via the applet. The web browser 110 interprets the HTML and displays a search page.

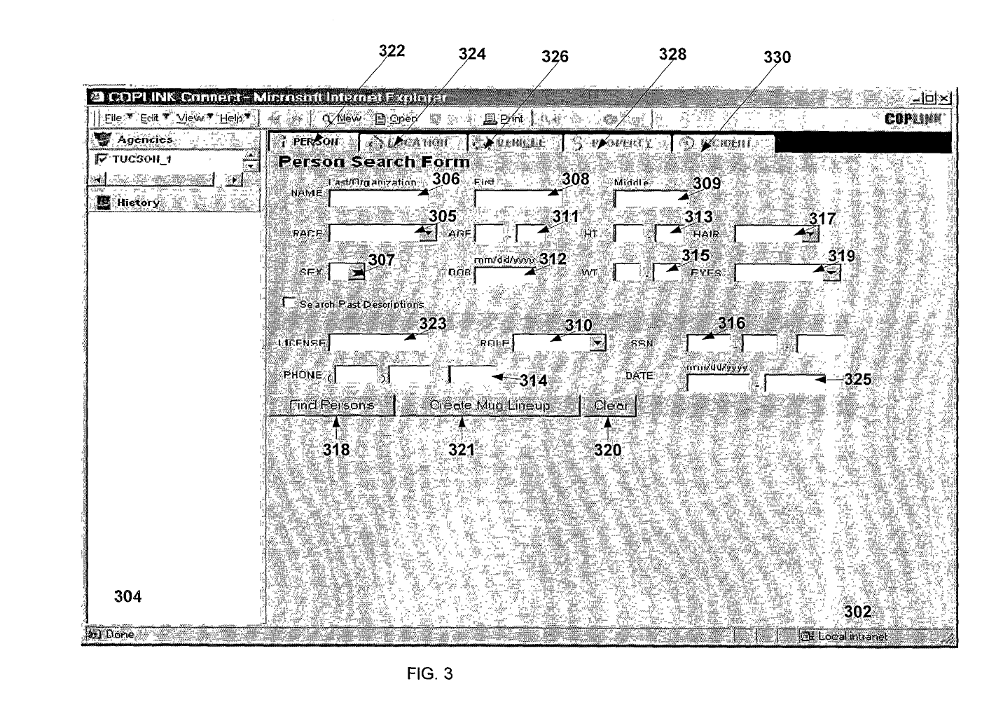

FIG. 3 is an exemplary search page for retrieving search parameters for searching the connect/detect database 106. Illustrated is a connect search screen 300 having a search from section 302 and a search history section 304. Search form 302 includes a race box 305, a last name/organization box 306, a sex box 307, a first name box 308, a middle name/initial box 309, a role box 310 for selecting the role of the individual such as suspect, victim, etc., an age box 311, a date of birth box 312, a height box 313, a phone number box 314, a weight box 315, a social security number box 316, a hair color box 317, an eye color box 319, a license box 323 for entering a driver license number, and a date box 325. Also included is a search button 318 for executing a search, a reset button 320 for resetting a page and a create mug shot button 321 that will retrieve images of persons matching the query. Along the top of search form 302 are a search tab 322, location tab 324, vehicle tab 326, incident tab 328 and property tab 330. Selecting these tabs will bring up the appropriate search forms such as a person search form, which is illustrated, a location search form, a vehicle search form, an incident search form or a property search form. While a specific person search form has been shown, the actual form and display of the search form is a matter of design choice.

The police officer utilizing the search system enters as much information as is available. For example, the police officer may have a partial first name of a suspect such as “Ed” provided by a witness. The officer, after accessing the person search form, would enter the name “Ed” into the first name block. Since “Ed” may be a common nickname, the officer could enter the name “Ed” along with a symbol that means to search for Ed and all first names that begin with “Ed”, such as the wildcard symbol “*”. After entering the information in the first name box 308 and selecting the search key 318, the data is sent to the web server 114 as an HTTP stream. Prior to sending the HTTP stream the data may be formatted, compressed and encrypted by applet 112.

The HTTP stream is received by the web server application 114 and decompressed and unencrypted utilizing a servlet 116. The web server application 114 takes the request, composes a database query and sends the information to the connect/detect database 106. This is typically done using a protocol such as JDBC.

In this search example, the connect database is being queried so the query will go to the connect views 120 and query the connect tables 122. As discussed previously, the connect table 122 is populated from one or more legacy databases 130. In this example, legacy databases may include a gang database, an incident database, a mug shot database, a narcotics database or any other database containing information helpful to law enforcement. Typically, these databases may be used by different individuals within a police department and may be proprietary in nature such that one cannot use a single interface to access the databases. The present invention uses the migration server 132 along with migration information stored in a XML file 134 to copy selected data from the legacy database 130 and populate the connect table 122. In this example, there could be more than one connect tables 122. For example, there could be a person table, an incident table, a gang table, a mug shot database and the like.

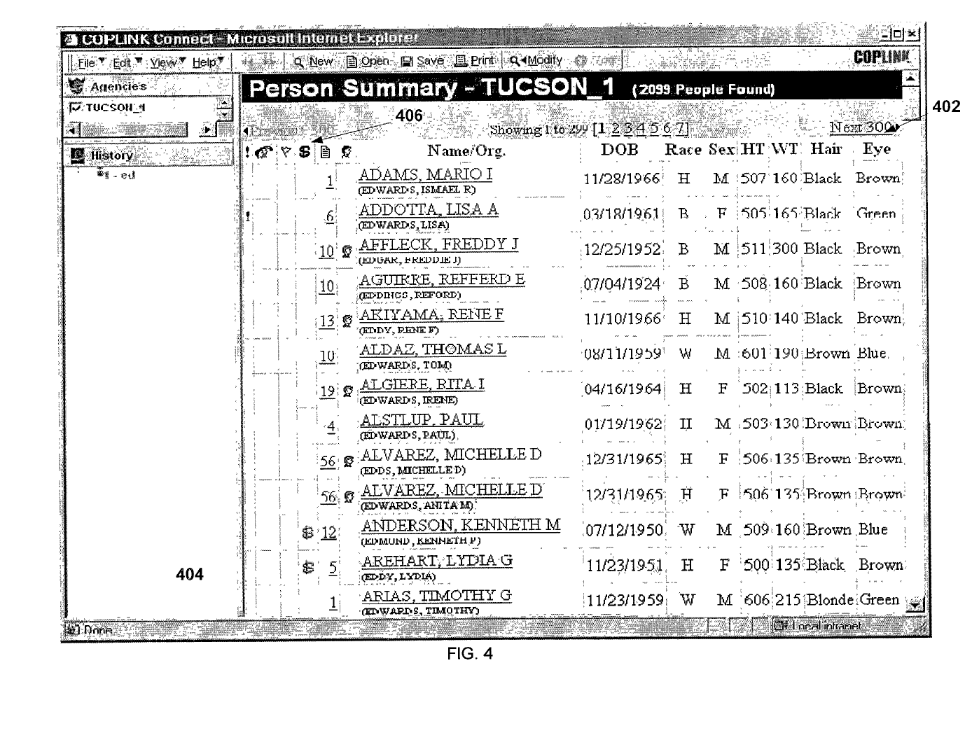

The query sent by the web server application 114 is received by the connect views 120 which searches and extracts the data from the connect tables 122. This information is then returned to the web server application 114 where a result table, preferably as a HTML screen, is populated and formatted and the results are returned to the web browser 110 in HTML format using an HTTP stream. The data can be compressed and encrypted at the server side by servlet 116 and then sent to the web browser 110. The applet 112 is then used to decompress and unencrypt the HTML or text. The web browser 110 renders the HTML and the result page 400 as seen in FIG. 4 is displayed.

FIG. 4 shows an exemplary result page 400 for a connect search. Illustrated are a result section 402 and a search history section 404. The result section 402 lists the search results in a table. All first names starting with “Ed” are listed along with the incident number the person is related to, the date of birth of the person if available, the height and weight of the individual if available, known gang affiliation if any and whether a mug shot is available. More details about the individual or incident can be selected and viewed. History section 404 keeps track of executed searches. Different icons 406 can be provided to provide a visual aid as to what type of person is identified. For example an “!” could mean the person was wanted, two heads and a gun may mean the person is part of a gang and a single head may mean a mug shot is available.

Thus, connect searches allows a user to search information that was previously located on one or more databases in an efficient and secure manner.

A police officer may also wish to search the detect portion of the connect/detect database 106. As discussed previously, the migration server 132 takes the terms stored in the connect tables 122 and analyzes the data to determine which terms or objects may be related to known terms or objects and stores these associations and relations in detect table 126.

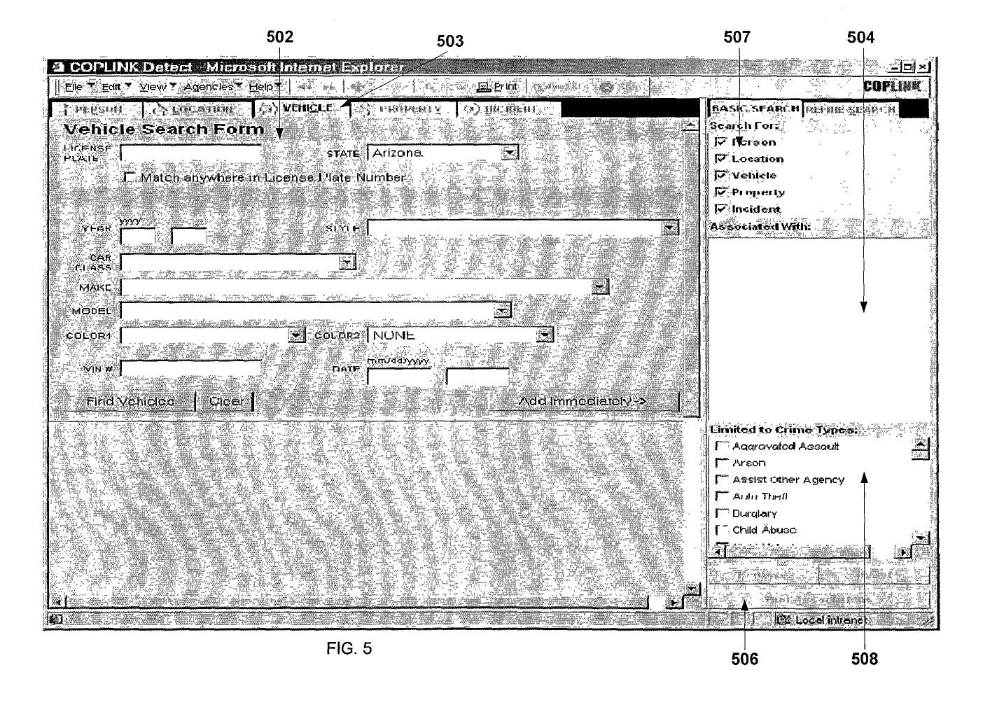

The procedures for executing a detect search are similar to that for executing a connect search. After connecting to the appropriate location and indicating that a detect search is to be done, a detect search page 500 is displayed on web browser 110 as shown in FIG. 5.

Detect search page 500 includes a search form section 502 and a detect search section 504. In search form section 504 a user can enter the term or object along with the specifics about the object such as “vehicle-white pickup” in the blanks of section 504. Then, by selecting the add button, the search term is added to the detect search section 504. The user can then check what objects to search for that are associated with the object or term being searched on in search for box 507. For example, the user can check the boxes for person, location or incident to see if the search object-“vehicle-white pickup” is related to any person, location or incident. The user can also limit the search to certain crime type by selecting limited to crime types box 508. The user will then select run search button 506. Different search pages can be selected by choosing tabs 503. The different pages can be a vehicle search page, an incident search page, a person search page, a property search page and a location search page.

The query will then be sent to detect views 124. In this case detect tables 126 will be queried. As discussed previously, the detect table 126 will be populated from the information extracted from the legacy databases 130. This information, along with information from the relation builder XML file 136, will be used by the relation builder/migration server 132 to determine the relationships between objects. The results are stored in the detect tables 126.

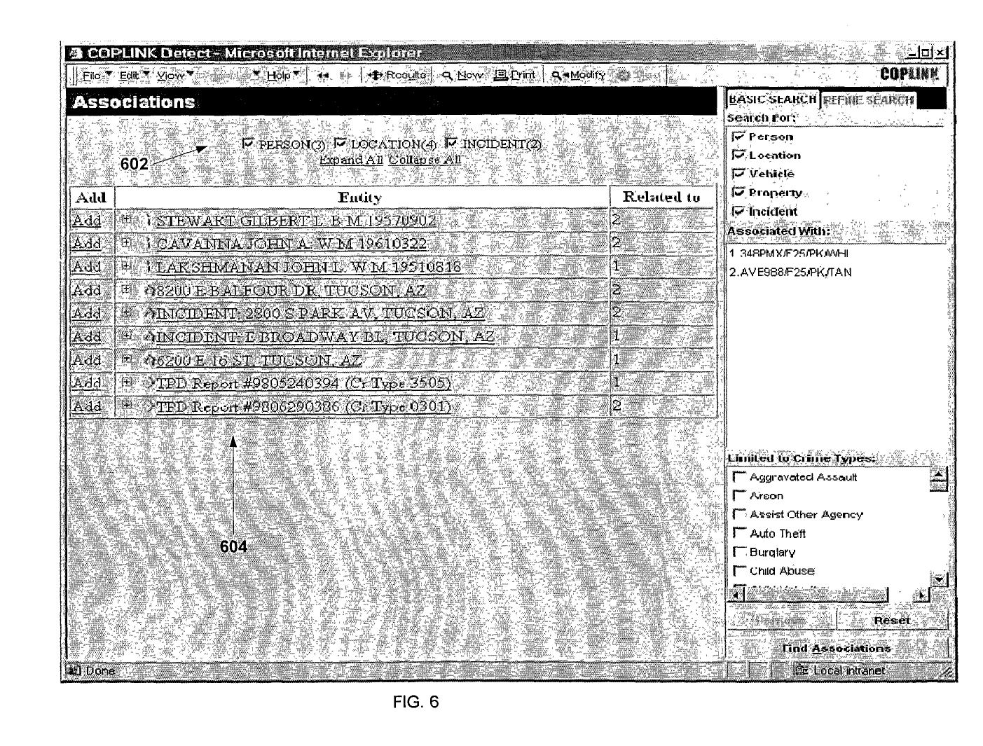

The query then returns data as discussed previously. Web browser 110 will display detect result screen 600 as seen in FIG. 6.

Detect result screen 600 of FIG. 6 includes a result section 604 that will list objects that are related to the detect search object. For example, one or more persons might be related to the “vehicle-white pickup” as entered into the search. The names of these persons will then be listed in the result section 604. The result section 604 will also include a summary section 602 that lists how many vehicles, locations, persons and incidents were found that were related to the search term or object.

Thus, the inclusion of a detect search database allows for an investigator who has knowledge of one term or object to find related terms of objects.

An advantage of the present invention is that a web enabled database solution with platform independent links into non-proprietary databases provides a very flexible and easily modified system. The use of a web browser and applets allows for flexibility in designing and delivering a front-end as opposed to a hard coded application. A web browser along with an applet also decreases the program load that needs to be downloaded to a client computer.

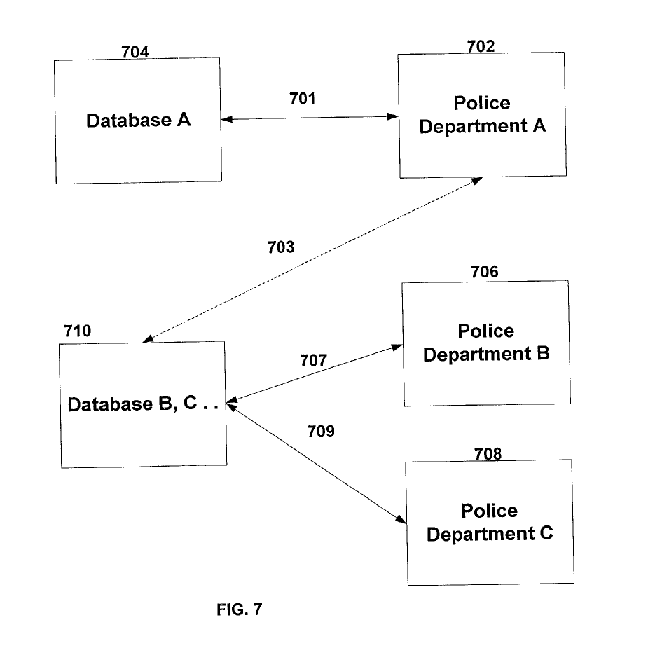

FIG. 7 is a block diagram of a multi-server embodiment of the present invention. Illustrated is Police Department A 702 having a web server of the present invention associated with a database A 704 also of the present invention. Also illustrated are Police Department B 706 and Police Department C 708, which both contain web servers of the present invention. Police Department B 706 and Police Department C 708 are associated with a database B, C 710, also of the present invention.

Police Department A 702 is a police department having jurisdiction over a certain area. It maintains its own database, database A 704. Database A 704 is designed in accordance with the teachings of the present invention. Police Department A 702 is able to access the database A 704 via a direct connection 701. Direct connection 701 may be any wireless or wired connection.

Police Department B 706 and Police Department C 708 are other police departments. Police Department B 706 and Police Department C 708 share multiple databases B, C 710. Databases B, C 710 are other databases designed in accordance with the present invention. Police Department B 706 and Police Department C 708 can run queries on databases B, C 710 and information returned could contain data derived from Police Department B 706 and Police Department C 708.

Police Department A is also able to access databases B, C 710 via connection 703. Connection 703 can be any wired or wireless connection, direct or over a network. In some embodiments of this invention, this connection can be encrypted and secured. In one embodiment the connection is over the Internet wherein a user at Police Department A 702 is using a web browser to access databases B, C, 710.

Having now described preferred embodiments of the invention, modifications and variations to the present invention may be made by those skilled in the art. The invention is thus not limited to the preferred embodiments, but is instead set forth in the following clauses and legal equivalents thereof.

What is claimed:

1. A method for retrieving law enforcement data from one or more legacy databases comprising:
forming a law enforcement database by migrating data from one or more legacy databases and storing the results in a one or more tables;
receiving a search query containing one or more search terms related to a law enforcement at a web server coupled to the law enforcement database; and
retrieving data matching at least one or more of the search terms from the law enforcement database based on the search query.

2. The method of claim 1 wherein the step of forming a law enforcement database further comprising storing the data along with the association between the data in a detect table.

3. The method of claim 2 wherein the step of storing the data further comprising storing the data along with the association between the data in the one or more tables

4. The method of claim 1 wherein the search query is based on a person, location, vehicle, property or incident.

5. The method of claim 2 wherein the search query is based on a person, location, vehicle, property or incident associated with one or more other person, location, vehicle, property or incident.

6. The method of claim 1 wherein the step of forming a law enforcement database further comprises using a migration server to extract information from the legacy database and to populate the one or more tables using the extracted information and a format file.

7. The method of claim 6 wherein the format file is an extensible markup language file.

8. The method of claim 1 wherein the step of receiving a search query further comprising receiving a search query from a client computer coupled to the web server.

9. The method of claim 8 wherein the step of receiving a search query from a client computer further comprises receiving a search query from a client computer coupled to the web server via an Internet connection.

10. The method of claim 8 further comprising sending the data matching at least one or more search terms to the client computer.

11. The method of claim 8 wherein the step of receiving a search query further comprises receiving an encrypted search query from a client computer coupled to the web server.

12. An integrated police database search system comprising:
a law enforcement database formed by migrating existing data from one or more pre-existing databases;
a server coupled to the law enforcement database, the server operable to receive search requests having one or more law enforcement search terms, the server operable to parse the search request and to retrieve data matching at least one or more of the search terms, the server further operable to send the data back to a user.

13. The system of claim 12 wherein the legacy database comprises databases from one or more different law enforcement jurisdictions.

14. The system of claim 12 wherein the legacy database comprises databases from one or more database structures that are incompatible.

15. The system of claim 12 wherein the server is a web server.

16. The system of claim 12 further comprising a plurality of servlets running on the server to provide data encryption.

17. The system of claim 12 wherein the server is accessible by one or more client computers coupled to the server.

18. The system of claim 17 wherein each of the one or more client computers are running a web browser.

19. The system of claim 12 wherein the database further comprises a detect view operable to receive a search query and return information associated with the data retrieved by the search request.

20. The system of claim 12 wherein a connect view in the database is operable to receive a search query and returning data related to one or more search terms in the search query.

21. The system of claim 17 wherein the one or more clients are coupled to the server via a connection over the Internet.

22. The system of claim 12 further comprising a migration server operable to extract information from the one or more pre-existing databases.

23. The system of claim 12 wherein the migration server receives information from a format file to assist in the population of the law enforcement database.

24. The system of claim 23 wherein the format file is an XML file.

25. A method for retrieving law enforcement data from one or more law enforcement databases comprising:
accessing a law enforcement search site using a web browser running on a client computer;
receiving search requests at the law enforcement search site as user input to a search form;
forming a database query from the search request at a server;
querying a law enforcement database using the database query, the law enforcement database formed by migrating data from one or more pre-existing legacy law enforcement databases.

26. The method of claim 25 further comprising the step of automatically updating the law enforcement database when information is added to the one or more pre-existing legacy law enforcement databases.

27. The method of claim 25 wherein the step of receiving a search request comprises receiving a search request to search for data contained in the search request as well as data associated with the data retrieved by the search request.

28. A system for searching a police database comprising:
a client computer operable to run a web browser;
a server computer coupled to the client computer, the server running a web server operable to send and receive search pages from the client computer;
a police database coupled to the server, the police database formed by migrating information from one or more legacy databases using a migration tool to format information in legacy database for use in the police database.

29. The system of claim 28 wherein the police database comprises a detect view for searching for data related to a search term.

30. The system of claim 28 wherein the police database is automatically updated when data is added to the one or more legacy databases.
